(19) United States
(12) Patent Application Publication
(10) Pub. No.: US 2013/0168878 A1
(43) Pub. Date: Jul. 4, 2013

(54) FLOTATION SYSTEM FOR WASTEWATER TREATMENT

(71) Applicants: Renzo Longhi, Manno (CH); Alessandro Jermini, Manno (CH); Urs Arnold, Lugano (CH)

(72) Inventors: Renzo Longhi, Manno (CH); Alessandro Jermini, Manno (CH); Urs Arnold, Lugano (CH)

(73) Assignee: SUPSI SCUOLA UNIVERSITARIA PROFESSIONALE DELLA SVIZZERA ITALIANA, ICIMSI, Manno (CH)

(21) Appl. No.: 13/809,676

(22) PCT Filed: Jul. 11, 2011
(86) PCT No.: PCT/IB11/01606

§ 371 Date: Mar. 22, 2013

(30) Foreign Application Priority Data
Jul. 12, 2010 (CH) 01126/10

(51) Int. Cl. C02F 1/24

(52) U.S. Cl. CPC C02F 1/24
USPC 261/64.1; 261/74

(57) ABSTRACT

A flotation clarification system (1) for wastewater includes: at least one main tank (2) defining a vertical central axis and having a bottom (3) at least a lateral wall (4); at least one sludge collecting device (5) for sludge to be treated; at least one unit (20) for adding air bubbles to water and/or sludge to be treated; and at least one water retaining tank (31). The unit (20) for adding air bubbles includes: at least one duct (33) for a flow of water and/or sludge to be treated; at least one duct (34) for a flow of water added with air; and at least one mixing device (35) configured and dimensioned so that the flow of water added with air is positioned inside the flow of water and/or sludge to be treated and runs into the latter while expanding radially from the inside towards the outside or vice versa.

The present invention relates to the field of wastewater treatments.

Particularly, the present invention relates to a clarification system of the flotation type for wastewater treatment and more particularly to a clarification system of the induced air flotation type.

Generally, in known induced air flotation systems, the impurities are separated from the water using air. Generally, in “DAF” (Dissolving Air Flotation) systems, impurities are mechanically separated from the water by adding water saturated with air at 5-6 bar. The air is dissolved in the water by means of an ADT Air Dissolving Tube mounted upstream of the input installation, and expanded by means of an expansion valve to obtain small bubbles of 30-40 micron which adhere to the impurity particles and reduce their specific weight, making them to reach the surface, where they are removed by means of a suitable scraper.

Known installations generally comprise, beside the air feeding system, a cylindrical main tank defining a vertical axis and, at the top thereof, an Archimedes' screw for collecting the sludge added with the micro-bubbles.

The Applicant has first of all noted that in known clarification systems of the flotation type for wastewater treatment the aeration systems are provided with a duct for mixing water with air, at least one compressor and at least one expansion valve.

The mixing between water added with air and the sludge occurs simply by connecting the duct containing water added with air to the duct containing the sludge, by means of a plain connection, for example a “T” joint.

The Applicant has further noted that in known clarification systems of the flotation type for wastewater treatment or in those mentioned above there are a high power consumption and a low efficiency in the mixing of water added with air with water to be treated and/or sludge.

The Applicant has found that the abovementioned problems may be overcome with a clarification system of the flotation type for wastewater treatment in which the mixing between the flow of water added with air and the flow of water to be treated and/or sludge occurs in such a way that the two flows, during this step, are coaxial with each other and by means of a radial expansion from the inside towards the outside of at least one flow relative to the other.

In a first aspect thereof, the invention therefore relates to a clarification system of the flotation type for wastewater treatment comprising:
at least one main tank defining a vertical central axis X-X and having at least a bottom and at least a lateral wall;
at least one sludge collecting device for sludge to be treated;
at least one unit for adding air bubbles to water to be treated and/or sludge;
at least one water retaining tank for water to be treated;
characterized in that:
said unit for adding air bubbles comprises:
at least one duct for a flow of water to be treated and/or sludge;
at least one duct for a flow of water added with air; and
at least one mixing device configured and dimensioned so that the flow of water added with air is positioned inside the flow of water to be treated and/or sludge and runs into the latter while expanding radially from the inside towards the outside or vice versa.

The present invention, in the above-mentioned aspect, may comprise at least one of the preferred features hereinafter described.

Preferably, the mixing device is configured and dimensioned so that the flow of water added with air is positioned coaxially inside the flow of water to be treated and/or sludge.

Conveniently, the duct for the flow of water added with air is arranged coaxially inside the said at least one duct for the flow of water to be treated and/or sludge.

Preferably, the unit for adding air bubbles further comprises at least one expansion valve arranged upstream of the said at least one duct for the flow of air added with water, at least one air dissolving tube and at least one connection for a compressor.

Advantageously, the mixing device is arranged at an end of the duct for the flow of water added with air.

Preferably, the mixing device comprises at least one divergent portion and at least one diffuser element.

Conveniently, the diffuser element is arranged at least partially inside the divergent portion for defining with the latter a passage and an outlet for the flow of water added with air.

Additionally, the diffuser element is arranged at least partially inside the divergent portion so as to define with the latter a passage and an outlet with adjustable cross sections for the flow of air added with water.

Advantageously, the separator unit is arranged close to at least one mixing device for increasing the probability that a sludge particle and/or flock combines with an air bubble.

Preferably, the system has three ducts for a flow of water to be treated and/or sludge, each arranged coaxially outside a duct for a flow of water added with air.

Advantageously, at least one water retaining tank is stationary and arranged inside the main tank.

Conveniently, the collecting duct is arranged downstream of the retaining tank and is in fluid communication with the three ducts for the flow of water to be treated and/or sludge.

Additionally, the system has at least one rotary intermediate tank, arranged inside the main tank and outside the water retaining tank.

Preferably, the sludge collecting device is adapted to rotate about the said vertical central axis X-X and comprises:
at least one chute collecting ramp;
at least one sludge collecting tank connected with the said collecting ramp; and
at least one conveyor device comprising:
at least one collecting vane adapted to define a rotation axis Y-Y substantially perpendicular to the vertical central axis X-X;
at least one motor operatively connected with the said collecting vane for making the said collecting vane to rotate about the said axis Y-Y.

Preferably, the system may comprise at least one movable bridge which supports the collecting device and the said intermediate tank and is adapted to rotate above at least one main tank.

Advantageously, the main tank and the water retaining tank have a height L greater than or equal to 50 cm.

Preferably, the conveyor device comprises at least one elongate body arranged along the rotation axis Y-Y and at least one support element for the said at least one collecting vane rotatably mounted on the elongate body.

Conveniently, the conveyor device comprises at least three collecting vanes substantially extended in the direction of the axis Y-Y and radially spaced apart from one another about the elongate body.

Further features and advantages of the invention shall become clearer from the detailed description of some preferred, but not exclusive, embodiments of a clarification system of the flotation type for wastewater treatment according to the present invention.

The description shall be made hereafter with reference to the accompanying drawings, provided only for indicating and non-limiting purposes, wherein:

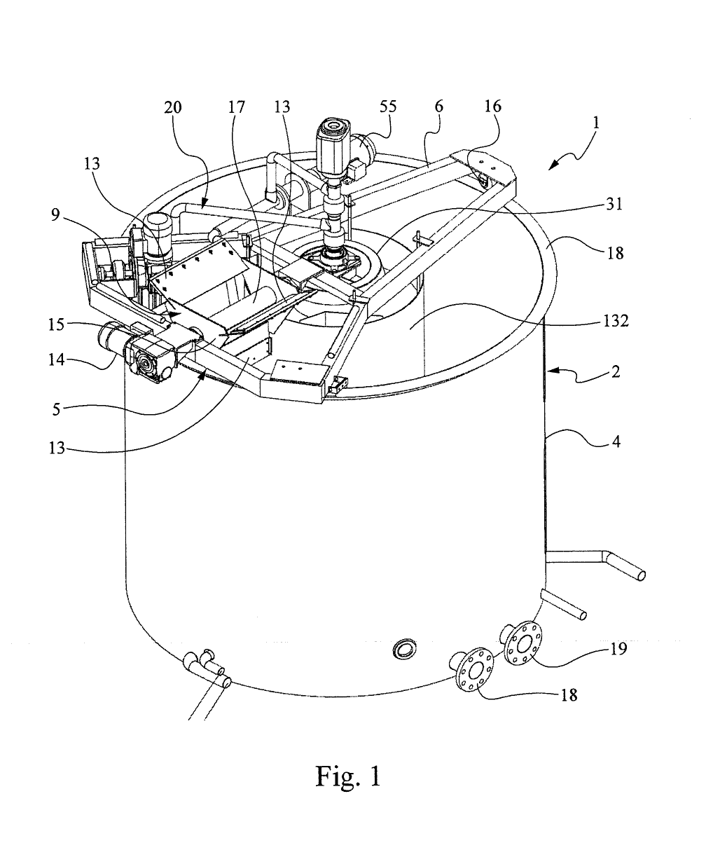

FIG. 1 is a schematic perspective view of a clarification system of the flotation type for wastewater treatment according to the present invention;

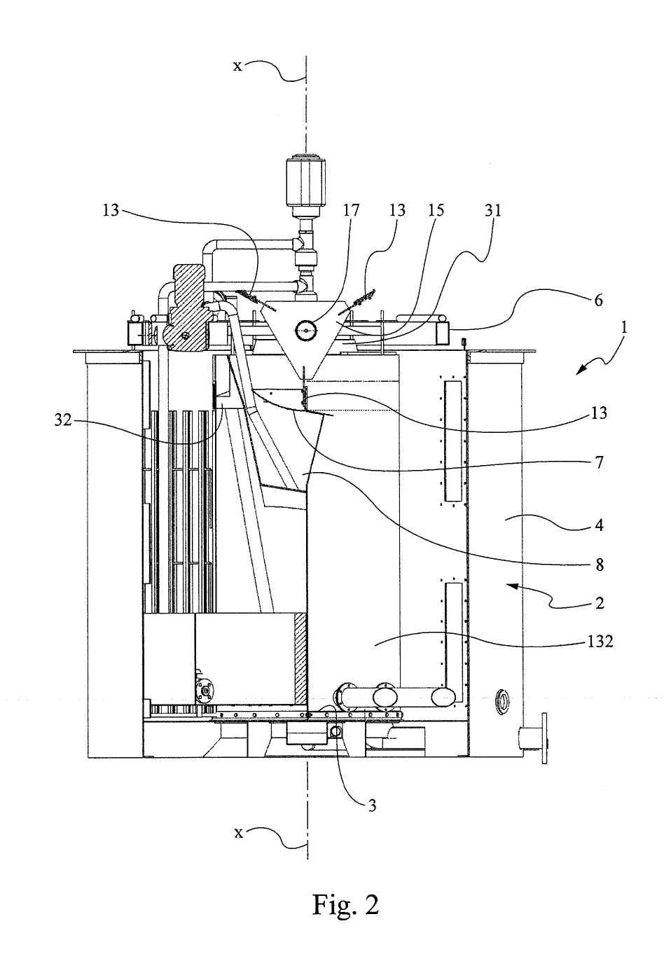

FIG. 2 is a sectional lateral view of a clarification system of the flotation type for wastewater treatment according to the present invention;

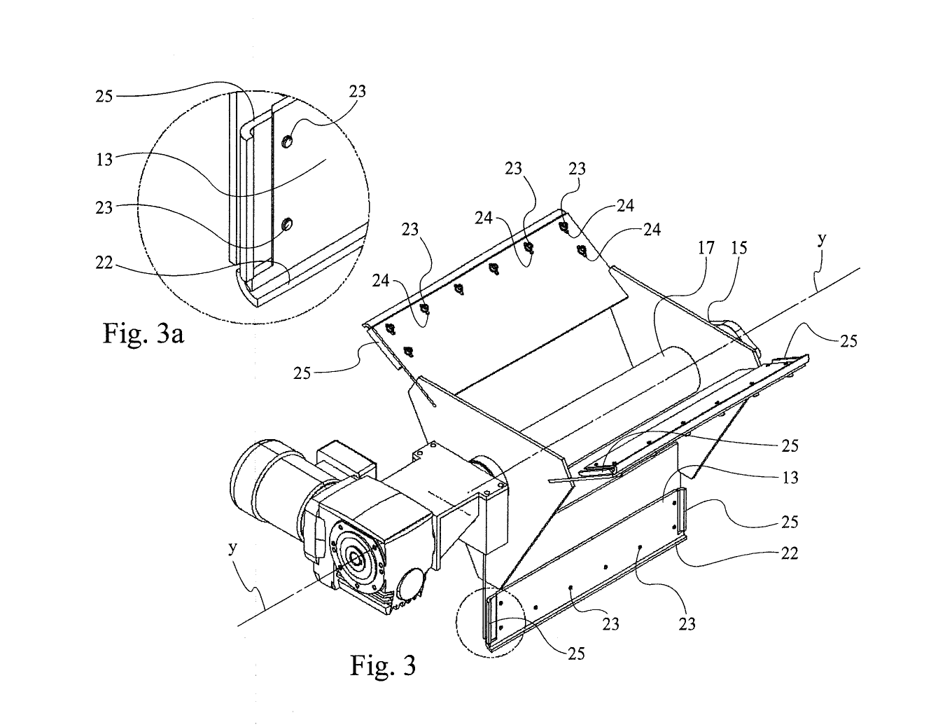

FIG. 3 is a schematic perspective view of a first embodiment of the conveyor device according to the present invention;

FIG. 3a is a schematic view of a detail of the conveyor device shown in FIG. 3;

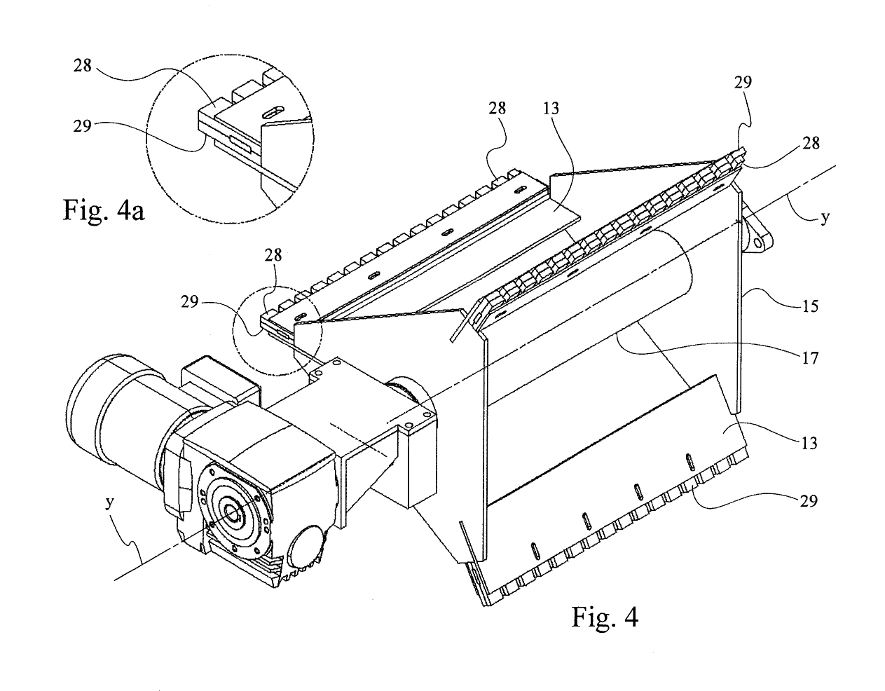

FIG. 4 is a schematic perspective view of a second embodiment of the conveyor device according to the present invention;

FIG. 4a is a schematic of a detail of the conveyor device shown in FIG. 4;

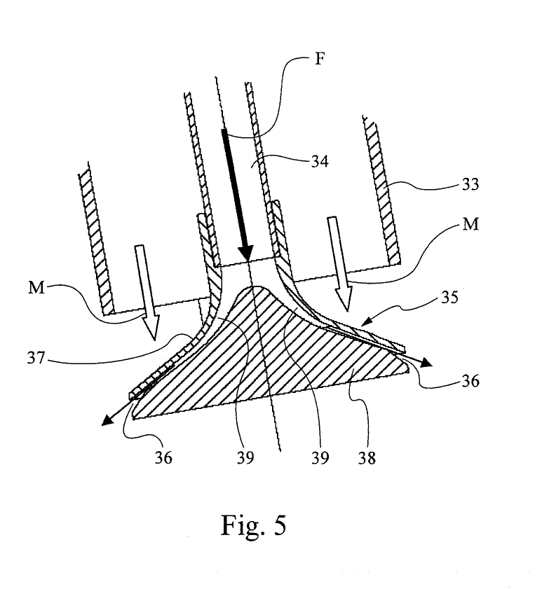

FIG. 5 is a schematic partially sectional view of the mixing device according to the present invention; and

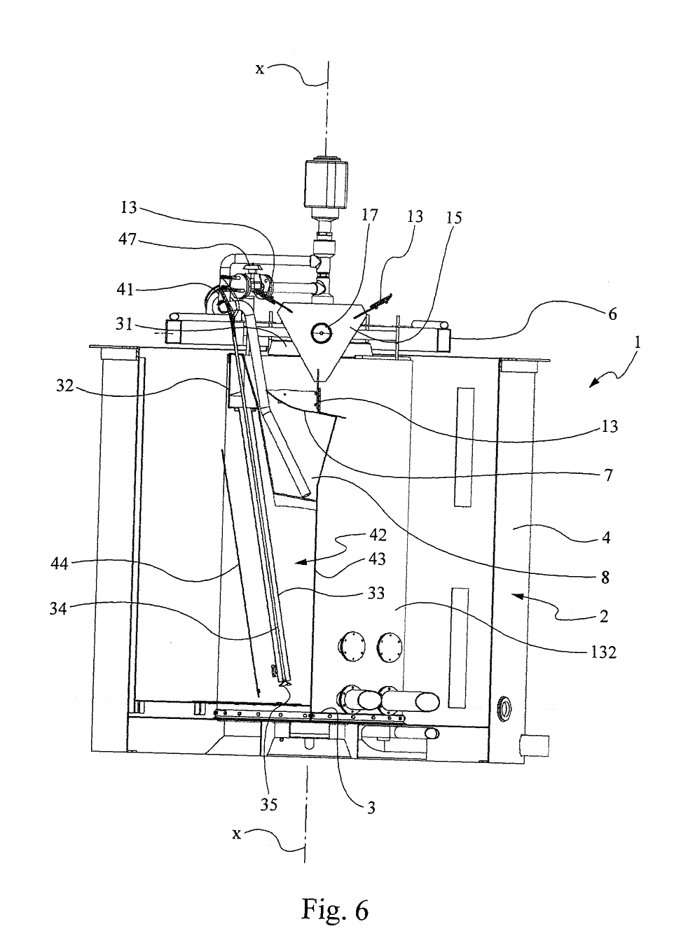

FIG. 6 is a schematic sectional lateral view of the clarification system of the flotation type for wastewater treatment according to the present invention.

Referring to FIGS. 1-2, a clarification system of the flotation type for wastewater treatment according to the present invention is indicated with reference numeral 1.

The clarification system 1 comprises a main tank 2, preferably of cylindrical shape, comprising a bottom 3 and a lateral wall 4. The main tank 2 extends about a vertical axis of symmetry X-X. Above the main tank 2 there is a collecting device 5 for collecting water and/or sludge to be treated which is adapted to rotate about the said central axis X-X.

For this purpose, the sludge collecting device 5 is connected to a movable bridge 6 provided with wheels 16 or other sliding elements adapted to slide on the upper edge 18 of the main tank 2, so as to allow the collecting device 5 to rotate about the axis X-X.

The main tank 2 further has, at the bottom 3 thereof, an inlet 18 for dirty water to be treated and an outlet 19 for treated clean water.

Moreover, the system 1 is provided with a unit 20 for adding air bubbles to the sludge to be treated, which is better seen in FIG. 6, and a water retaining tank 31.

The water retaining tank 31 is arranged inside the main tank 2.

In detail, the water retaining tank 31 has a substantially cylindrical shape and is arranged coaxially inside the main tank 2.

Advantageously, the water retaining tank 31 is stationary and develops vertically about the axis X-X starting from the bottom of the main tank 2.

The system 1 is further provided with an intermediate tank 132 for the treated water.

The intermediate tank 132 is arranged inside the main tank 2 and outside the water retaining tank 31.

In detail, the intermediate tank 132 has a substantially cylindrical shape and is arranged coaxially inside the main tank 2 and outside the water retaining tank 31.

Advantageously, the intermediate tank 132 is rotatable about the central axis X-X and, for this purpose, is supported by and connected to the movable bridge 6.

The main tank 2 as well as the water retaining tank 31 and the is intermediate tank 132 have a height greater than 50 cm, preferably greater than 70 cm, in any case lower than 10 m, for example equal to 80 cm.

At the upper portion thereof, the water retaining tank 31 is in fluid communication with a collecting duct 32, whose purpose shall be described in detail hereinafter, while at the lower portion thereof, the water retaining tank 31 is in fluid communication with the inlet 18 for dirty water to be treated.

In the retaining tank 31 preferably the dirty water to be treated, which entered through the inlet 18 for dirty water to be treated, is mixed with a chemical reactant.

Further to the mixing with the chemical reactant, the dirty water is transformed into a glutinous substance in form of sludge flocks and/or particles and leaves the water retaining tank 31 from above, reaching the collecting duct 32.

The dirty water to be treated in from of sludge flocks and/or particles thus spills out into the collecting duct 32 and is subsequently mixed with micro-bubbles by means of the unit 20 for adding air bubbles to the air to be treated.

For this purpose, the unit 20 preferably comprises at least one duct 33 for a flow of water and/or sludge to be treated, at least one duct 34 for a flow of water added with air and at least one mixing device 35 configured and dimensioned so that the flow of water added with air is positioned inside the flow of water and/or sludge to be treated and runs into the latter while expanding radially from the inside towards the outside or vice versa.

Advantageously, for a better mixing the flow of water added with air, as indicated by arrow F in FIG. 5, is positioned coaxially inside the flow of water and/or sludge to be treated, indicated by arrows M in FIG. 5.

Preferably, the mixing device 35 is arranged in the lower portion of the main tank 2.

Advantageously, the mixing device is arranged at a height lower than ⅓ of the total height L of the main tank 2.

This choice allows, on the one hand, increasing the probability that air bubbles bond with the sludge particles and/or flocks when they rise from the bottom of the main tank 2, and, on the other hand, avoiding the sedimentation of sludge particles or flocks on the bottom of the main tank 2.

In the embodiment shown in the figures, there are three ducts 33, of which only one is represented in FIG. 6, for the flow of water and/or sludge to be treated, each containing at least one duct 34 for the water added with air.

The three ducts 33 for the flow of sludge each containing the respective duct for the water added with air are arranged outside the retaining tank 31, radially spaced apart from one another moving away from the axis X-X.

Each duct 34 for the water added with air extends substantially over the whole length of the duct 33 for the water and/or sludge to be treated.

Moreover, still referring to the embodiment shown in FIGS. 5, 6, the flow of water and/or sludge to be treated is positioned concentrically outside the flow of water added with air.

In other words, the flow of water and/or sludge to be treated is positioned substantially on a circumference outside the flow of water added with air. At the mixing device 35, the flow of water added with air runs into the flow of water and/or sludge to be treated while expanding substantially radially from the inside towards the outside, see FIG. 5.

For this purpose, each mixing device 35 comprises at least one outlet 36 for the flow of water added with air, at least one divergent portion 37 directly mounted at one end of the duct 34 for the flow of water added with air and at least one diffuser element 38.

The substantially bell-shaped diffuser element 38 has an outer shape which is substantially counterprofiled with respect to the shape of the divergent portion 37, and is arranged at least partially inside the divergent portion 37 for defining with the latter a passage 39 and the outlet 36 for the flow of water added with air.

The radially outer surface of the divergent portion cooperates with the duct for the flow of water and/or sludge to be treated for defining an outlet 40 for the sludge right at the outlet 36 for the water added with air.

For this purpose, the divergent portion 37 projects axially with respect to the duct 33 for the water and/or sludge to be treated.

Adjustment elements may further be present for varying the cross section of the passage 39 and of the outlet 36 for the flow of water added with air.

As better shown in FIGS. 2 and 6, flexible small tubes 41 are arranged downstream the duct for the sludge and the duct for conveying the water added with air, each connected at one of their ends with a duct 33 for the water added with air and, at the other end, with an expansion valve 47, which allows air bubbles to be generated.

For this purpose, upstream the expansion valve 47 there are a duct for dissolving air, usually known with the acronym ADT (Air Dissolving Tube), a connection for a compressor and a compressor, not shown in the figure.

The expansion valve 47 may be operated by a motor and the system 1 may comprise a control circuit for setting the expansion valve 47 in order to achieve a constant and optimal pressure.

While leaving the mixing device 35, the flow of water added with air mixes with the sludge particles and/or flocks coming from the duct 33 for the water and/or sludge to be treated.

The mixing phase is a crucial step for the process. It is indeed at this stage that the sludge particles in form of flocks combine with the passing air bubbles.

The sludge particles combined with the air bubbles will then have a tendency to move upwards towards the upper edge of the main tank 2, where they can be collected by the sludge collecting device 5, as described in detail hereinafter.

For increasing the effectiveness of the combination between air bubbles contained in the water added with air and sludge particles and/or flocks, the system comprises at least one separator unit 42 arranged close to the mixing device.

In detail, the separator unit 42 has a vertical bulkhead 43 and a slanted bulkhead 44 adapted to define a portion of the main tank 2 which encloses the mixing devices 35 and at least partially the ducts 33 for the water and/or sludge to be treated.

The vertical bulkhead 43 extends substantially radially to the axis X-X over at least ⅔ of the height L of the main tank 2. Preferably, the vertical bulkhead 43 extends from the bottom 3 of the main tank 2 to the sludge collecting device 5.

The slanted bulkhead 44 as well extends radially to the axis X-X over at least ⅔ of the height L of the main tank 2, but is slanted relative to the plane defining the vertical bulkhead 43.

In detail, the slanted bulkhead 44 extends from the lower portion of the main tank 2, preferably leaving a gap with respect to the bottom 3 of the main tank 2.

The slanted bulkhead 44 extends along a substantially slanted direction, parallel to the extension direction of the ducts 33 for the water and/or sludge to be treated.

The sludge flocks and/or particles mixed the air bubbles reach the surface of the main tank 2 where they will be removed by means of a suitable sludge collecting device 5.

The sludge collecting device 5 comprises at least one chute collecting ramp 7 connected with at least one sludge collecting tank 8 arranged inside the main tank 2, at the upper end thereof, and at least one conveyor device 9.

During the operation of the system 1, as anticipated above, water impurities which have been suitably fed to the tank 2 through the inlet 18, the inner retaining tank 31 and the duct 33 for the water and/or sludge to be treated, come to the surface by means of the flotation process in form of sludge flocks and/or particles, added with air bubbles. The sludge in said form, whose level is shown in FIG. 2 by a dashed line, is conveyed towards the chute collecting ramp 7 and from there, by means of the conveyor device 9, better described hereinafter, into the collecting tank 8, from which it will be timely extracted by means of a suitable pump 55.

The system 1 has a pump 55 arranged above the collecting tank 8.

The pump 55 is preferably a screw pump arranged above the intermediate tank 132.

At this point the clarified water, i.e. the clean water at the bottom of the main tank 2, is extracted.

This operation is possible thanks to the presence of two pipes arranged at the bottom of the main tank 2.

A fraction of the clarified water which has been extracted is provided to the unit 20 for adding air bubbles to the water and/or sludge to be treated.

Advantageously, the sludge collecting tank 8 has a receiving capacity greater than 90 l, preferably greater than 100 l.

Preferably, the sludge collecting tank 8 has a limited vertical development and extends preferably over less than 50% of the height of the main tank 2, so that the subsequent extraction work for removing the sludge by means of the pump 55 is reduced.

The conveyor device 9 has a central elongate body 17 defining a rotation axis Y-Y substantially perpendicular to the central axis X-X.

The said elongate body 17 is rotatably connected to the movable bridge 6 and supports at least one, preferably three, collecting vane(s) 13. The elongate body 17, and thus the collecting vanes 13, are operatively connected with a motor 14, preferably an electric motor, which provides for the rotary motion of the elongate body 17, and thus of the collecting vanes 13, about the axis Y-Y.

Preferably, the said motor 14 is an electric gearmotor, for allowing the is rotation speed to be set and different rotation regimes for the collecting vanes 13 to be obtained.

In the embodiment shown in the figures, the collecting vanes 13 have an elongate, substantially rectangular and flat shape.

The collecting vanes 13 are connected to the elongate body 17 by means of two support elements 15.

In the embodiment shown in the figures the axial dimension of the collecting vanes 13 varies between 300 and 600 mm, however vanes with different dimensions can be conceived without departing from the scope of protection of the invention.

The support elements 15 are rotatably mounted on the elongate body 17 at a predetermined distance from each other, which substantially corresponds to the maximum dimension of the collecting vane 13 along the direction Y-Y.

Each support element 15 comprises at least one ball bearing for mounting on the elongate body 17.

Each support element 15 further has attachment elements for the collecting vanes 13, such as for example suitable guides 21 adapted to receive at least a portion of the collecting vanes 13.

The three collecting vanes 13 are angularly positioned and equally spaced apart about the elongate body 17 and, for this purpose, the guides 21 as well are angularly spaced apart about the elongate body 17.

In FIGS. 3 and 3a a first embodiment of the conveyor device 9 is shown.

According to this first embodiment, a first scraper element 22 is provided for each collecting vane 13 and is arranged at the radially outer end of the collecting vane 13 itself.

The first scraper element 22 has a substantially rectangular shape and extends over the whole axial length of the collecting vane 13.

Preferably, the first scraper element 22, at the free end thereof, i.e. the radially outermost end with respect to the axis Y-Y, has an edge which bends during operation, as shown in the figures, for perfectly adhering to the surface of the chute ramp 7.

Advantageously, the first scraper element 22 is made of a flexible material.

Preferably, the first scraper element 22 is made of rubber.

For adjustably connecting each scraper element 22 to a collecting vane 13, an adjustment device is provided on the collecting vane 13 for adjusting the distance between the said scraper element 22 and the chute ramp 7.

Preferably, the distance adjustment device comprises suitable grooves 24 configured for removably receiving fastening screws 23. The grooves 24 extend, over a predetermined length, perpendicularly to the axis Y-Y and allow adjusting the position of the first scraper element 22 relative to the collecting vane 13 and thus of the first scraper element 22 relative to the chute ramp 7.

Conveniently, further two second scraper elements 25 arranged at the axially outer end of the said collecting vane 13 may be provided.

The second scraper elements 25 extend for at least 20% of the radial extension of the collecting vane 13.

Also the second scraper elements 25 are made of rubber and have and outer portion which bends during operation, as shown in the figures, for perfectly adhering to the surface of the chute ramp 7.

In FIGS. 4 and 4a a second embodiment of the conveyor device 9 is shown which is totally similar to the previous one, leaving out the presence of an adjustment device 27, instead of the first scraper element 25, at the radially outer edge of the collecting vane 13, for controlling the density of the sludge to be collected.

Preferably, each adjustment device 27 comprises at least two blades 28, 29, of which at least one, preferably both, is/are provided with a plurality of teeth 30 spaced out by gaps.

The two blades 28, 29 are adapted to axially slide relative to each other and to be fixed in a different axial position based on the density of the sludge to be collected.

Preferably, each adjustment device 27 comprises a guide bar interposed between the said blades 28, 29, for the sliding of one blade relative to the other.

For adjustably connecting the said blades 28, 29 to a collecting vane 13, an adjustment device for adjusting the distance between the said blades 28, 29 and the chute ramp 7 is provided on each collecting vane 13.

Also in this case, the distance adjustment device comprises suitable grooves 24 configured for removably receiving fastening screws 23. The grooves extend, over a predetermined length, perpendicularly to the axis Y-Y and allow an adjustment of the position of the scraper element relative to the collecting vane, and thus of the blades 29, 28 relative to the chute ramp 7.

The present invention has been described with reference to some embodiments thereof. Many modifications can be introduced in the embodiments described in detail, still remaining within the scope of protection of the invention, which is defined by the appended claims.

1. Clarification system (1) of the flotation type for wastewater treatment comprising:
at least one main tank (2) defining a vertical central axis X-X and having at least a bottom (3) and at least a lateral wall (4);
at least one sludge collecting device (5) for sludge to be treated;
at least one unit (20) for adding air bubbles to water and/or sludge to be treated;
at least one water retaining tank (31);
characterized in that:
said unit (20) for adding air bubbles comprises:
at least one duct (33) for a flow of water and/or sludge to be treated;
at least one duct (34) for a flow of water added with air; and
at least one mixing device (35) configured and dimensioned so that the flow of water added with air is positioned inside the flow of water and/or sludge to be treated and runs into the latter while expanding radially from the inside towards the outside or vice versa.

2. Clarification system of the flotation type for wastewater treatment according to claim 1, characterized in that said at least one mixing device (35) is configured and dimensioned so that the flow of water added with air is positioned coaxially inside the flow of water and/or sludge to be treated.

3. Clarification system of the flotation type for wastewater treatment according to claim 1, characterized in that said at least one duct (34) for the flow of water added with air is positioned coaxially inside the said at least one duct (33) for the flow of water and/or sludge to be treated.

4. Clarification system of the flotation type for wastewater treatment according to claim 1, characterized in that said unit (20) for adding air bubbles further comprises at least one expansion valve (47) arranged upstream of the said at least one duct (34) for the flow of air added with water.

5. Clarification system of the flotation type for wastewater treatment according to claim 1, characterized in that said mixing device (35) is arranged at an end of the duct (34) for the flow of water added with air.

6. Clarification system of the flotation type for wastewater treatment according to claim 5, characterized in that said mixing device (35) comprises at least one divergent portion (37) and at least one diffuser element (38).

7. Clarification system of the flotation type for wastewater treatment according to claim 6, characterized in that the diffuser element (38) is arranged at least partially inside the divergent portion (37) for defining with the latter a passage (39) and an outlet (36) for the flow of water added with air.

8. Clarification system of the flotation type for wastewater treatment according to claim 1, characterized by comprising a separator unit (42) arranged close to the said at least one mixing device (35) for increasing the probability that sludge particles and/or flocks combine with the air bubbles.

9. Clarification system of the flotation type for wastewater treatment according to claim 1, characterized in that said at least one water retaining tank (31) is stationary and arranged inside the said main tank (2).

10. Clarification system of the flotation type for wastewater treatment according to claim 1, characterized by comprising at least one collecting duct (32) downstream of the said water retaining tank (31), in fluid communication with the said at least one duct (33) for the flow of water to be treated.

11. Clarification system of the flotation type for wastewater treatment according to claim 9, characterized by comprising at least one rotary intermediate tank (132), arranged inside the said main tank (2) and outside the said water retaining tank (31).

12. Clarification system of the flotation type for wastewater treatment according to claim 1, characterized in that said sludge collecting device (5) is adapted to rotate about the said vertical central axis X-X and comprises:
at least one chute collecting ramp (7);
at least one sludge collecting tank (8) connected with the said collecting ramp (7); and
at least one conveyor device (9) comprising:
at least one collecting vane (13) adapted to define a rotation axis Y-Y substantially perpendicular to the vertical central axis X-X;
at least one motor (14) operatively connected with the said collecting vane (13) for making the said collecting vane (13) to rotate about the said axis Y-Y.

13. Clarification system of the flotation type for wastewater treatment according to claim 1, characterized by comprising at least one movable bridge (6) which supports the said collecting device (5) and the said intermediate tank (132) and is adapted to rotate above the said at least one main tank (2).

14. Clarification system of the flotation type for wastewater treatment according to claim 1, characterized in that said main tank (2) and said water retaining tank (31) have a height L greater than or equal to 50 cm.

15. Clarification system (1) of the flotation type for wastewater treatment according to claim 1, characterized in that said conveyor device (9) comprises at least one elongate body (17) arranged along the rotation axis Y-Y and at least one support element for the said at least one collecting vane (13) rotatably mounted on the said elongate body (17).

16. Clarification system of the flotation type for wastewater treatment according to claim 2, characterized in that said at least one duct (34) for the flow of water added with air is positioned coaxially inside the said at least one duct (33) for the flow of water and/or sludge to be treated.

17. Clarification system of the flotation type for wastewater treatment according to claim 10, characterized by comprising at least one rotary intermediate tank (132), arranged inside the said main tank (2) and outside the said water retaining tank (31).
